(19) United States
(12) Patent Application Publication
(10) Pub. No.: US 2008/0164447 A1
(43) Pub. Date: Jul. 10, 2008

(54) Stake Pulling Device and Method

(76) Inventor: Glenn Tsuyoshi Hironaga, Honolulu, HI (US)

Correspondence Address: ITALIA IP, 3500 WEST OLIVE AVE., SUITE 300, BURBANK, CA, 91505, US

(21) Appl. No.: 11/621,964

(22) Filed: Jan. 10, 2007

(51) Int. Cl. B66F 19/02; F16B 15/00

(52) U.S. Cl. 254/30; 411/487

(57) ABSTRACT

A stake pulling device for pulling a stake in an upward direction from the ground, the device including a stake that includes means by which a pin can be secured to; and a jack wherein the jack includes pin engagement means for engagement of said secured pin such that when said jack is raised, the stake is pulled in an upward direction from the ground. The application also includes a stake device suitable for removal by a pulling device and various methods of pulling a stake in an upward direction.

### BACKGROUND OF INVENTION

This application relates generally to the field of devices that are used for the removal of stakes, posts, rods, or the like, which have been driven into, or otherwise placed into the ground. More specifically, this application relates to a stake pulling device and a method of pulling such stakes from the ground.

In the construction industry in particular, it is frequently necessary to drive stakes and into the ground to support foundation members. The stakes and posts become very difficult to remove under most circumstances since they are generally directly pressing against the foundation members, or the like, and thus when it is time to remove the stakes, it is very difficult to get an appropriate bearing position to exert force against them.

In light of this difficulty, it has become common place to remove foundation stakes by either breaking them off, or hitting them repeatedly with hammers to loosen them in the ground, or simply pounding them below the surface and leaving them to rot away. Such procedures are costly and usually result in the destruction of the stakes and create additional cost and expense by reason of excessive time required. As such, this application discloses various embodiments that enable a user to economically and efficiently pull such stakes from the ground.

### SUMMARY

This application discloses a variety of embodiments that enable a user with a suitable means with which to pull a stake in from the ground The embodiments are economical to produce, of simple construction and capable of mass production.

In particular, this application discloses a stake pulling device for pulling a stake in an upward direction from the ground, the device including a stake that includes means by which a pin can be secured to and a jack wherein the jack includes pin engagement means for engagement of said secured pin such that when said jack is raised, the stake is pulled in an upward direction from the ground.

This application also discloses a stake saddle device for adapting to a stake that is to be pulled from the ground by a jack and where the stake includes means by which a pin can be secured to, and whereby the saddle device includes pin engagement means and jack engagement means.

This application also discloses a stake device that includes a generally elongated shank having a ground piercing portion at one end and a head portion at the other, wherein the head portion includes a driving portion for receiving a blow in order to drive the stake into the ground, and an engagement portion for engaging said stake to a removing means.

This application also discloses a stake engagement device that is capable of engaging a stake that is directly pressing against foundation members. The stake engagement device includes a body that includes a tool engagement means at one end a stake engagement means at the other.

Further, this application discloses a method of pulling a stake in an upward direction that has been driven into the ground. In one embodiment the method includes the steps of securing a pin through the stake, engaging the pin to a jack adapted to receive said pin, and raising the jack and thereby pulling the stake in an upward direction.

This application also discloses a method of pulling a stake in an upward direction that has been driven into the ground, wherein in this embodiment the method includes the steps of securing a pin through the stake, seating said secured pin to a saddle, engaging the saddle to a jack adapted to receive said saddle, and raising the jack and thereby pulling the stake in an upward direction.

This application also discloses another method of pulling a stake in an upward direction that has been driven into the ground, whereby in this method the steps include engaging the head portion of the stake to a jack adapted to receive said head portion, and raising the jack and thereby pulling the stake in an upward direction.

Further, this application discloses a stake and jack assembly that includes a stake that comprises a generally elongated shank having a ground piercing portion at one end and a head portion at the other, wherein the head portion includes a driving portion for receiving a blow in order to drive the stake into the ground, and an engagement portion for engaging said stake to a jack, and wherein said jack includes means to mateably receive the engagement portion of said stake, and wherein the stake includes at least one planar surface capable of directly pressing against foundation members when said stake device is driven into the ground, and wherein the stake is capable of being engaged by the jack when the stake is directly pressing against foundation members.

Finally, this application discloses a stake and stake engagement device assembly which includes a stake that comprises a generally elongated shank having a ground piercing portion at one end and a head portion at the other, wherein the head portion includes a driving portion for receiving a blow in order to drive the stake into the ground, and an engagement portion for engaging said stake to a stake engagement device, and wherein said stake engagement device comprises a body that includes a tool engagement means at one end a stake engagement means to mateably receive the engagement portion of said stake at the other, and wherein the stake includes at least one planar surface capable of directly pressing against foundation members when said stake device is driven into the ground, and wherein the stake is capable of being engaged by the stake engagement device when the stake is directly pressing against foundation members.

### BRIEF DESCRIPTION OF THE DRAWINGS

The drawings, when considered in connection with the following description, are presented for the purpose of facilitating an understanding of the subject matter sought to be protected.

FIG. 1 is a perspective view of a first embodiment of the stake pulling device;

FIG. 2 is an enlarged perspective view of the stake engagement portion of the device in FIG. 1;

FIG. 3 is a perspective view of a second embodiment of the stake pulling device;

FIG. 4 is an enlarged perspective view of the stake engagement portion of the device in FIG. 3;

FIG. 5 is a perspective view of a first embodiment of a stake saddle device;

FIG. 6 is a perspective view of the stake saddle device in FIG. 5 shown engaged with a stake;

FIG. 7 is a front view of the stake saddle device in FIG. 5 shown engaged with a stake;

FIG. 8 is a perspective view of the stake saddle device in FIG. 5 shown engaged with a stake and the saddle device engaged with a jack;

FIG. 9 is a perspective view of a second embodiment of a stake saddle device;

FIG. 10 is a perspective view of the stake saddle device in FIG. 9 shown engaged with a stake;

FIG. 11 is a front view of the stake saddle device in FIG. 9 shown engaged with a stake;

FIG. 12 is a perspective view of a stake device;

FIG. 13 is an enlarged perspective view of the head portion of the device in FIG. 12;

FIG. 14 is a perspective view on the stake engagement portion of a jack;

FIG. 15 is a perspective view of the head portion of the device in FIG. 12 shown engaged with the jack in FIG. 14;

FIG. 16 is a perspective view of a first embodiment of the stake engagement device;

FIG. 17 is a perspective view of the head portion of the device in FIG. 12 shown engaged with the stake engagement device of FIG. 16;

FIG. 18 is a side view of the head portion of the device in FIG. 12 shown engaged with the stake engagement device of FIG. 16;

FIG. 19 is a perspective view of a second embodiment of the stake engagement device;

FIG. 20 is a perspective view of the head portion of the device in FIG. 12 shown engaged with the stake engagement device of FIG. 19; and

FIG. 21 is a side view of the head portion of the device in FIG. 12 shown engaged with the stake engagement device of FIG. 19.

### DETAILED DESCRIPTION

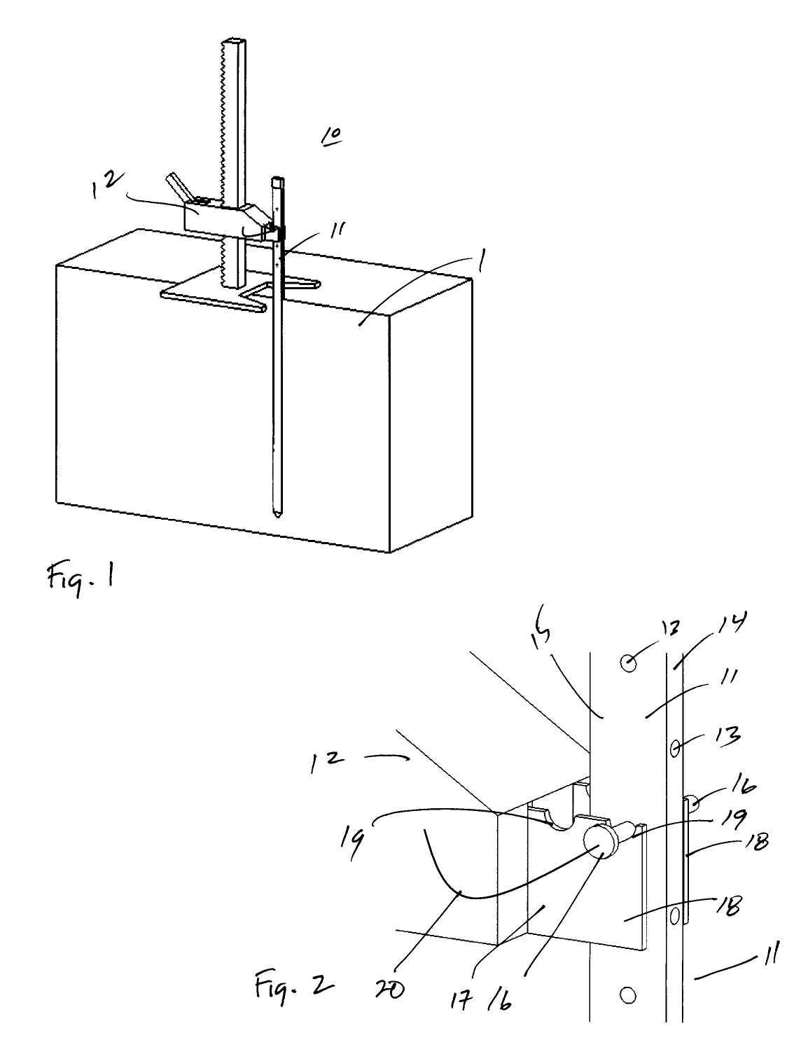

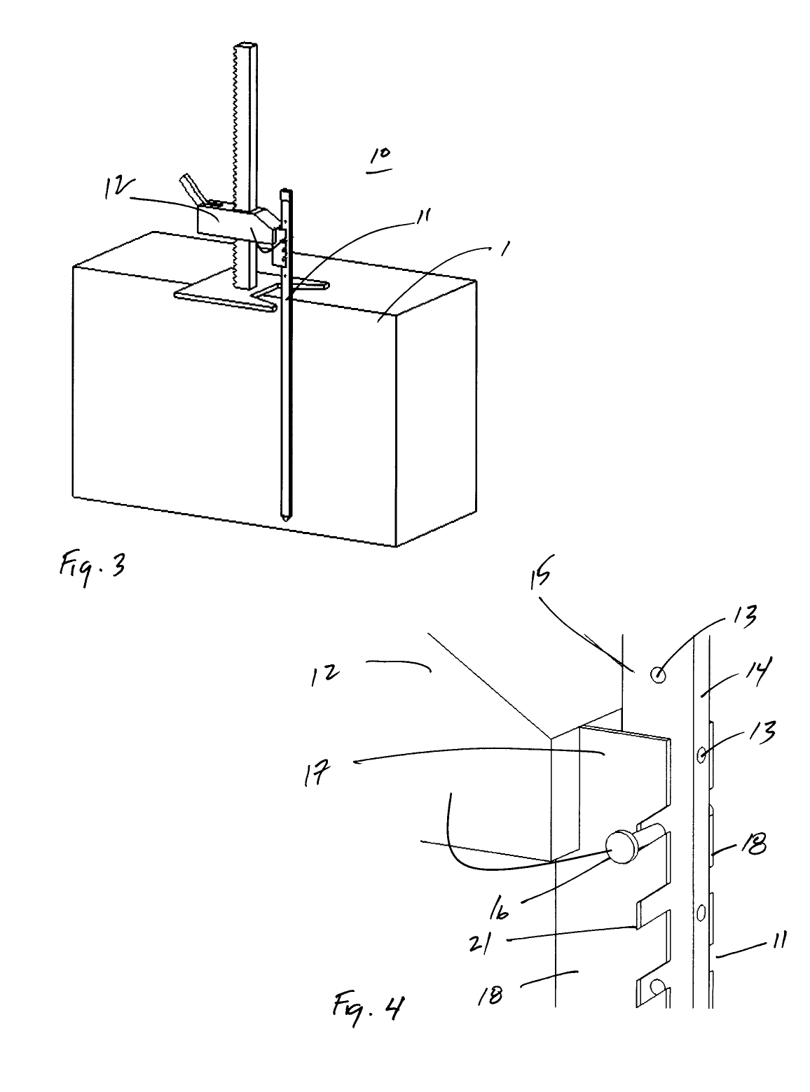

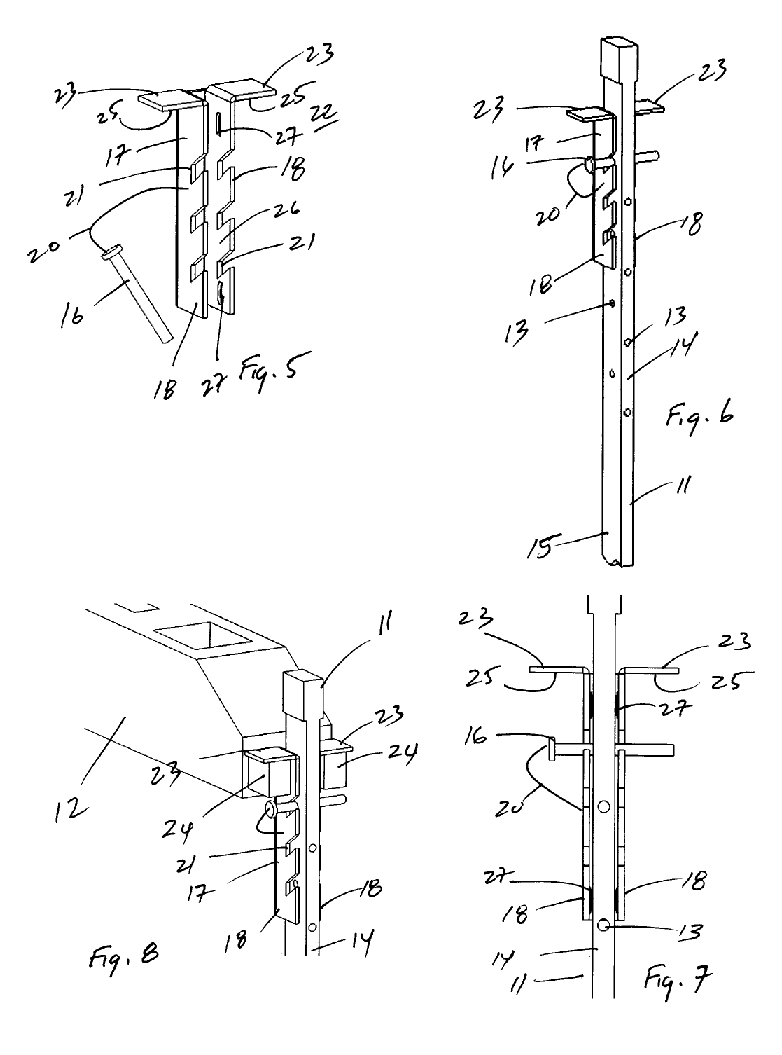

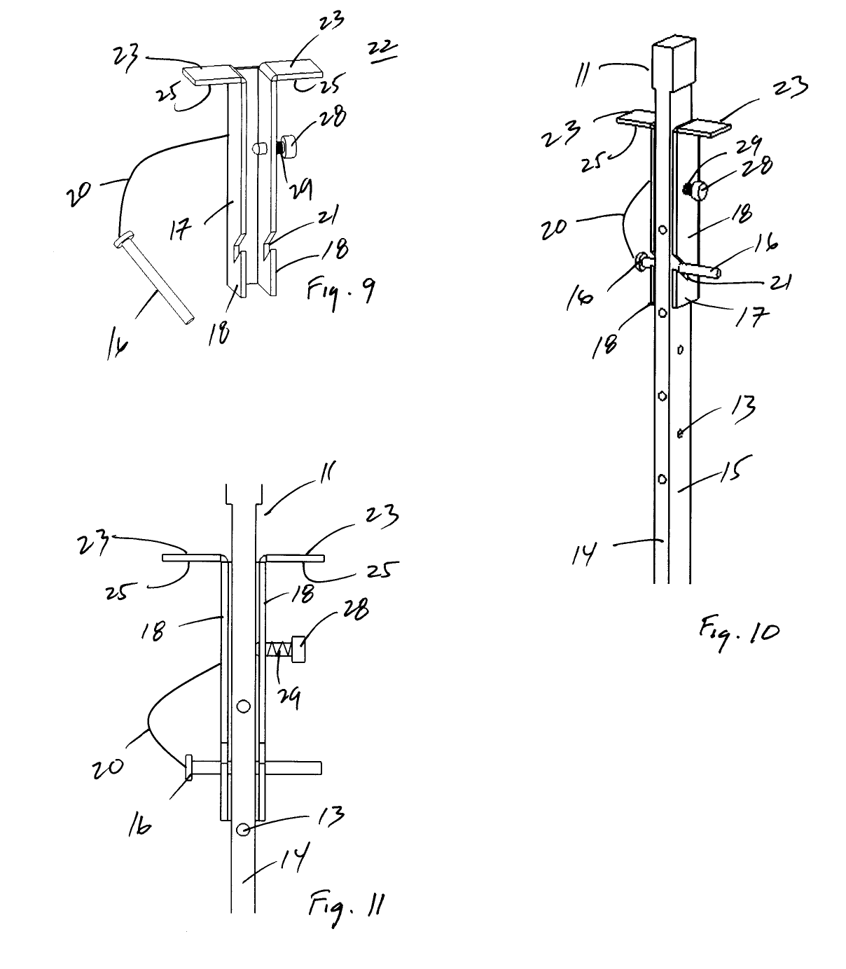

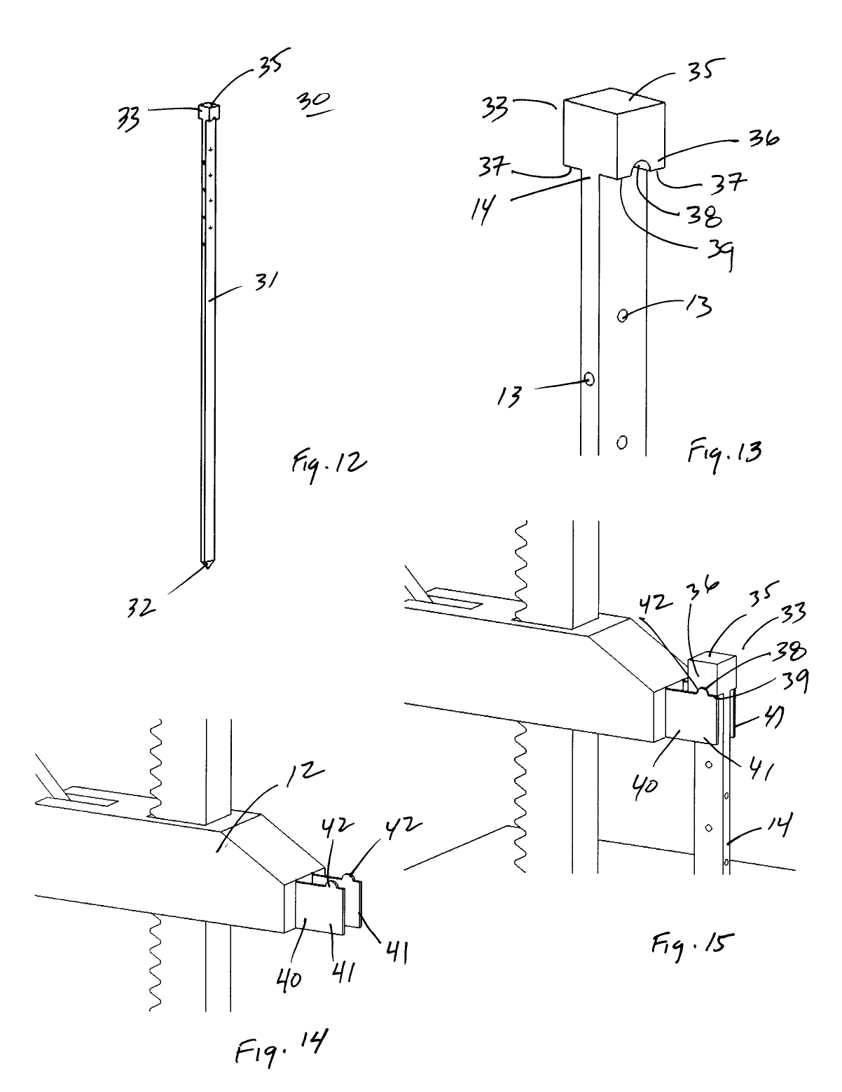

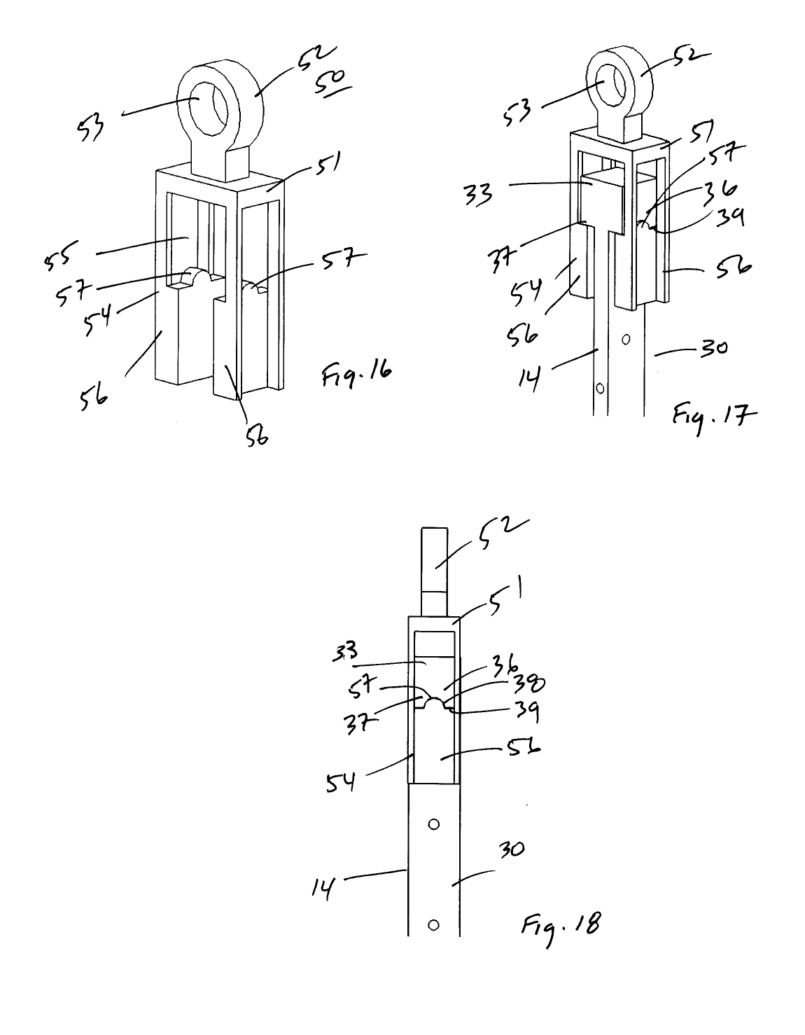

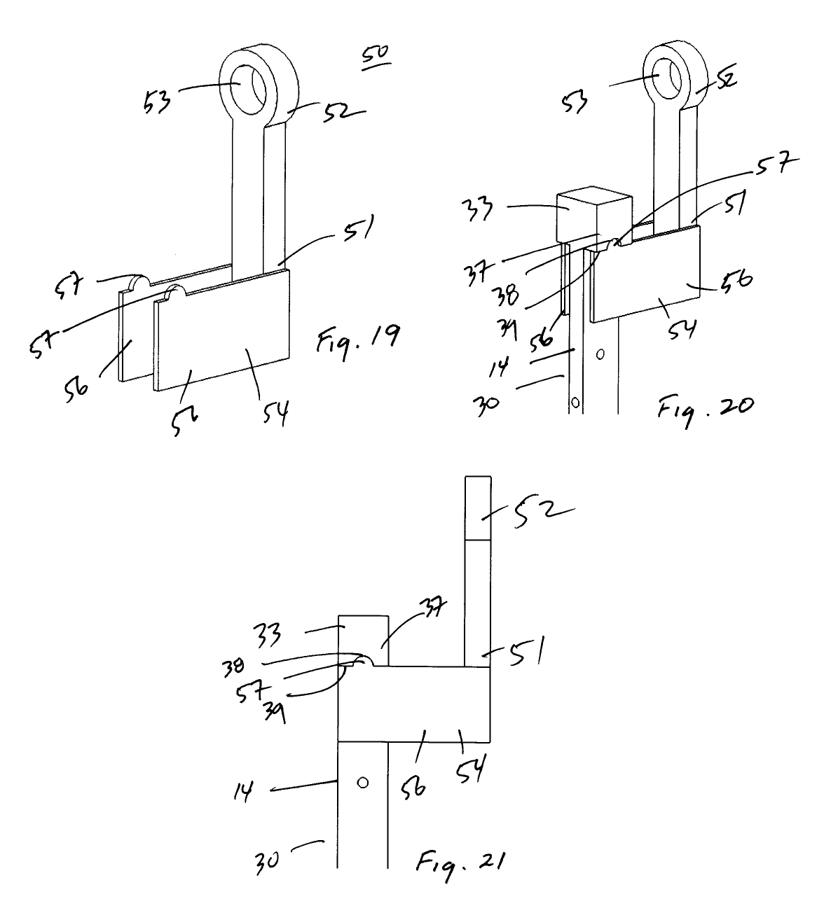

Referring to FIGS. 1 and 2, shown therein and generally designated by the reference character 10 is the first embodiment of stake pulling device 10 constructed in accordance with the following description. The device 10 comprises a stake 11 and a jack 12. As used herein, “stake” includes any like devices that can be driven into the ground 1. As is common to stakes that are used to support foundation members, the stake 11 includes bores 13 that pass through each side of the stake. The bores 13 on the surface 14 that abuts directly to the foundation member allows a user to secure the stake 11 to a foundation member by driving a nail through the desired bore 13 and into the foundation member. The bores 13 on the surface 15 that runs parallel to the foundation member allows a user secure a nail or pin 16 therethrough. This secured pin 16 creates a surface with which a vertical force can be applied by a jack 12 that includes a pin engagement portion 17. In the first embodiment, the pin engagement portion 17 includes a pair of projections 18 which may further include at least one or more pairs of grooves 19 which allow the pin 16 to remain seated in the pin engagement portion 17 when the jack 12 is raised. When the jack is raised, the force is transferred from the pin engagement portion 17, to the pin 16, which in turn causes the stake 11 to be raised in an upward direction from the ground 1. As shown, a pin 16 can be secured to the jack 12 by means of a leash 20 as is common in the art; however, a common nail of sufficient strength may also be used. As also shown, the projections 18 are of a sufficient length such that when the pin 16 is seated in the pin engagement portion 17, the device 10 is capable of engaging a stake 11 that may be directly pressing against foundation members on surface 14.

Referring to FIGS. 3 and 4, a second embodiment of the stake pulling device is shown. In this embodiment, the pin engagement portion 17 includes a pair of projections 18 and at least one pair of slanting cutouts 21 which allow the pin 16 to remain seated in the pin engagement portion 17 when the jack 12 is raised. Again, when the jack is raised, the force is transferred from the pin engagement portion 17, to the pin 16, which in turn causes the stake 11 to be raised in an upward direction from the ground 1. Again, as shown, a pin 16 can be secured to the jack 12 by means of a leash 20 as is common in the art, however, a common nail of sufficient strength may also be used. Likewise, the projections 18 are of a sufficient length such that when the pin 16 is seated in the pin engagement portion 17, the device 10 is capable of engaging a stake 11 that may be directly pressing against foundation members on surface 14.

During operation of either pulling device embodiment 10, the method of pulling a stake 11 in an upward direction that has been driven into the ground would include securing a pin 16 through the stake 11, engaging the pin 16 to a jack 12 adapted to receive the pin 16, and raising the jack 12 and thereby pulling the stake 11 in an upward direction.

Referring to FIGS. 5-8, a first embodiment of a stake saddle device 22 is shown and in FIGS. 9-11, a second embodiment of the saddle device 22 is shown. The saddle device 22 of each embodiment is similar to the pulling device 10 previously described in that each utilizes with a stake that includes bores 13 on the surface 15 that run parallel to the foundation member with which a user secure a nail or pin 16 therethrough. They are also similar in that they include a pin engagement portion 17 which includes a pair of projections 18 and at least one pair of slanting cutouts 21 which allow the pin 16 to remain seated in the pin engagement portion 17 when the jack 12 is raised. However, with each embodiment of the saddle device 22, a pair of flanges 23 are used as the jack engagement means whereby a jack 12 would include flange engagement portions 24 that are adapted to engage the lower surface 25 of the flanges 23. See FIG. 8 for an example of the first embodiment of the saddle device 22 engaged with a jack 12, the second embodiment is not shown; however, the engagement would be exactly the same.

The operation in pulling out a stake upward from the ground is different from the pulling device 10 described above in that with each embodiment of the saddle device 22, as the as jack 12 is raised, the force is exerted upon the lower surface 25 of the flanges 23 by the flange engagement portions 24 of the jack 12, the pin 16 is then seated firmly in the slanting cutouts 21, and the stake 11 is pulled in an upward direction. The basic operation would include securing a pin through the stake, seating the secured pin to the saddle 22, engaging the saddle 22 to a jack 12 adapted to receive the saddle 22, and raising the jack and thereby pulling the stake in an upward direction.

The saddle device 22 may also include saddle engagement means such that saddle is able to be retained upon the surface of the stake when the jack is not in place. This is accomplished by at least two ways and it what distinguishes the two embodiments of the saddle device 22. Referring to FIGS. 5 and 7, in the first embodiment, at least one flexible portion 27 (such a thin piece of metal) is used upon the inner surface 26 of the saddle such that when the stake 11 is place between the projections 18 of the saddle device 22, the device 22 remains engaged with the stake 11 by friction fit as the flexible portions 27 are deflected and exert a force upon the stake thereby holding the saddle device in the proper position until a jack 12 is brought into position to engage the flanges 23. Referring to FIGS. 9-11, the second embodiment includes at least one pinion 28 that may be threaded, or as shown, loaded with a spring 29 that is attached to at least one projection 18 of the saddle device. The user is a able to secure the saddle device 22 to the stake 11, in case of the spring loaded pinion, by pulling the pinion 28 out, inserting the stake between the stake 11 at the proper position between the projections 18 and releasing the pinion 29 thereby holding the saddle device 22 in the proper position by friction fit until a jack 12 is brought into position to engage the flanges 23. The method of using a threaded pinion 28 for the same purpose is common in the art and not described here. Further, as shown for each saddle device embodiment 22, a pin 16 can be secured to the saddle device 22 by means of a leash 20 as is common in the art, however, a common nail of sufficient strength may also be used.

Referring to FIGS. 12-13, shown therein and generally designated by the reference character 30 is stake device constructed in accordance with the following description. The stake device includes a generally elongated shank 31 having a ground piercing portion 32 at one end and a head portion 33 at the other, wherein the head portion includes a driving portion 35 for receiving a blow from a hammer or other like device, in order to drive the stake into the ground, and an engagement portion 36 for engaging said stake to a removing means as described more fully below. The stake may also include bores 13 about the length of the elongated shank or only at a designated portion. The stake device may also include at least one planar surface 14 that is capable of directly pressing against foundation members when said stake device is driven into the ground. As shown, the stake device contains two planer surfaces 14 on opposite sides of one another. As also shown, the engagement portion 36 includes ledged portions 37 that provide a surface to engage a removing means. In this case, the ledged portions 37 further include keyway portions 38 on the underside 39 of the ledged portions 37.

As shown in FIGS. 14 and 15, a removing means such as a jack 12 may include a stake engagement portion 40 which includes stake engagement projections 41 to mateably receive the engagement portion 36 of the stake 30. In this case, the stake engagement projections 41 include key portions 42 to mateably receive the keyway portions 38 on the underside 39 of the ledged portions 37 of the stake 30. Further, the stake engagement projections 41 are of a sufficient length such that when stake 30 is engaged with the jack, the stake is capable of being removed even when the head portion 33 is directly pressing against foundation members on the planer surface 14. During the basic operation of the jack 12 to pull the stake 30 from the ground, a user engages the head portion 33 of the stake to the jack 12 adapted to receive said head portion, and raises the jack thereby pulling the stake 30 in an upward direction.

Referring to FIGS. 16-18, a first embodiment of a stake removing means is shown in the form of a stake engagement device designated by the reference character 50 and in FIGS. 19-21, a second embodiment of the stake engagement device 50 is shown. Each embodiment of the stake engagement device 50 includes a body 51 that includes a tool engagement portion 52, in this case a loop portion 53, and at one end and a stake engagement portion 54 at the other.

Referring now specifically to the first embodiment of the stake engagement device 50 as shown in FIGS. 16-18, the device has a generally U-shape wherein the device includes a pass way 55 that is shaped to allow the head portion 33 of the stake 30 to pass through. The device 50 also includes a pair of stake engagement projections 56 that extend downward from the tool engagement portion 52 so as to mateably receive the engagement portion 36 of the stake 30 contained in the pass way 55. In this case, the stake engagement projections 56 include key portions 57 to mateably receive the keyway portions 38 on the underside 39 of the ledged portions 37 of the stake 30. Further, the stake engagement projections 56 are of a sufficient length such that when the stake 30 is engaged with first embodiment of the stake engaging device 50, the stake is capable of being removed even when the head portion 33 is directly pressing against foundation members on the planer surface 14. See FIG. 18.

Referring now specifically to the second embodiment of the stake engagement device 50 as shown in FIGS. 16-18, the device has a generally L-shape wherein the device 50 also includes a pair of stake engagement projections 56 that extend horizontally from the tool engagement portion 52 so as to mateably receive the engagement portion 36 of the stake 30. In this case, the stake engagement projections 56 also include key portions 57 to mateably receive the keyway portions 38 on the underside 39 of the ledged portions 37 of the stake 30. Further, the stake engagement projections 56 are of a sufficient length such that when the stake 30 is engaged with second embodiment of the stake engaging device 50, the stake is capable of being removed even when the head portion 33 is directly pressing against foundation members on the planer surface 14. See FIG. 21.

In each embodiment of the stake engagement device 50, the tool attachment portion can be utilized by a variety of means to create a force to pull the stake in an upward direction. Such means may include a jack, a prying device such a pry bar, or a backhoe.

It should also be appreciated that various means of engaging the stake 30 with the removing means disclosed herein are contemplated by the inventor such that any key way/key structure would be covered under the present disclosure.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1-6. (canceled)

7. A stake device comprising:
a generally elongated shank having a ground piercing portion at one end and a head portion at the other, wherein the head portion includes a driving portion for receiving a blow in order to drive the stake into the ground, and an engagement portion for engaging said stake to a removing means.

8. The stake device of claim 1 wherein the stake is capable of being engaged by a removing means when it is directly pressing against foundation members

9. The stake device of claim 2 wherein the removing means is a jack, and wherein the jack includes means to mateably receive the engagement portion of said stake.

10. The stake device of claim 2 wherein the removing means is a stake engagement device, and wherein the stake engagement device includes means to mateably receive the engagement portion of said stake at one end and tool engagement means at the other.

11. The stake device of claim 1 wherein the stake device includes at least one planar surface capable of directly pressing against foundation members when said stake device is driven into the ground.

12-21. (canceled)

22. A stake and stake engagement device assembly comprising:
a stake that comprises a generally elongated shank having a ground piercing portion at one end and a head portion at the other;
wherein the head portion includes a driving portion for receiving a blow in order to drive the stake into the ground, and an engagement portion for engaging said stake to a stake engagement device;
wherein said stake engagement device comprises a body that includes a tool engagement means at one end a stake engagement means to mateably receive the engagement portion of said stake at the other;
wherein the stake includes at least one planar surface capable of directly pressing against foundation members when said stake device is driven into the ground; and
wherein the stake is capable of being engaged by the stake engagement device when the stake is directly pressing against foundation members.
